(19) United States
(12) Patent Application Publication
(10) Pub. No.: US 2007/0131900 A1
(43) Pub. Date: Jun. 14, 2007

(54) Molded article of enhancing agent for inflator

(75) Inventor: Jianzhou Wu, Tatsuno-shi (JP)

Correspondence Address: BIRCH STEWART KOLASCH & BIRCH, PO BOX 747, FALLS CHURCH, VA, 22040-0747, US

(73) Assignee: Daicel Chemical Industries, Ltd., Sakai-Shi (JP)

(21) Appl. No.: 11/562,823

(22) Filed: Nov. 22, 2006

Related U.S. Application Data
(60) Provisional application No. 60/740,275, filed on Nov. 29, 2005.
(60) Provisional application No. 60/752,383, filed on Dec. 22, 2005.

(30) Foreign Application Priority Data
Nov. 25, 2005 (JP) 2005-339655
Dec. 20, 2005 (JP) 2005-366755

(51) Int. Cl. C11D 3/39

(52) U.S. Cl. 252/186.1

(57) ABSTRACT

The present invention provides a molded article of the enhancing agent having good ignition ability and producing less amount of mist. A molded article of the enhancing agent including (a) 20 to 50 mass % of a fuel including a bitetrazole salt; (b) 40 to 80 mass % of an oxidizing agent; (c) 1 to 20 mass % of a binder.

### TECHNICAL FIELD

The present invention relates to a molded article of an enhancing agent that can be used in a gas generator for an air bag in an automobile.

### BACKGROUND OF THE INVENTION

Most gas generators for air bags in automobiles use a gas generating agent serving as a gas source for inflating the air bag in combination with an enhancing agent serving as an auxiliary component for igniting and combusting the gas generating agent.

U.S. Pat. No. 5,623,115 discloses a molded article of an ignition material of a single grain or unitary grain type. In this molded article, ignition performance is improved by scattering metal particles at the time of ignition. JP-A No. 2000-515009 describes that ignition performance is improved by combining bitetrazole with specific metal particles.

However, with such technology using specific metal particles, unpreferably, the metal particles easily cause dust explosion and some of the metals (for example, boron) are expensive.

In the invention described in JP-A No. 2002-29879, a large number of bitetrazoles have to be used, whereby the workload in blending is increased and the production cost is raised. The invention described in JP-A No. 2000-319085 includes basic copper nitrate as an essential component. As a result, the combustion temperature is low and ignition ability is poor. JP-A No. 2004-83304 discloses a single grain or unitary grain type gas generating agent that has at least 19 holes. Because the number of small through holes is large, this agent is difficult to produce.

### SUMMARY OF THE INVENTION

The present invention provides a molded article of an enhancing agent that has a low cost, can be easily loaded into an inflator assembly, and has good ignition ability and produces less amount of mist.

The present invention provides a molded article of an enhancing agent including:

(a) 20 to 50 mass % of a fuel including a bitetrazole salt;

(b) 40 to 80 mass % of an oxidizing agent; and

(c) 1 to 20 mass % of a binder.

The molded article of the enhancing agent has a low cost, can be easily loaded into an inflator assembly, has good ignition ability, and generates small amount of mist.

### EMBODIMENTS OF THE INVENTION

Component (a)

Component (a) is a fuel including a bitetrazole salt, but it may also include another nitrogen-containing organic fuel. The bitetrazole salt can be monoammonium salt or diammonium salt or a metal salt such as an alkali metal salt (potassium salt, sodium salt, and the like), an alkaline earth metal salt (magnesium salt, calcium salt), copper salt, and zinc salt. In order to decrease the amount of mist in the combustion gas, monoammonium salt and diammonium salt are preferred.

For the fuel of component (a), in order to decrease the amount of mist in a combustion gas, the content ratio of the monoammonium salt or diammonium salt of bitetrazole is preferably 50 mass % or more, more preferably 70 mass % or more, and even more preferably 80 mass % or more.

Examples of other nitrogen-containing fuels may include tetrazole compounds other than the above, guanidine compounds, triazine compounds and nitroamine compounds.

Examples of other tetrazole compounds may include tetrazole, 5-aminotetrazole, 5,5′-bi-1H-tetrazole, and 5-nitroaminotetrazole.

Examples of guanidine compounds may include guanidine, mono-, di-, or triaminoguanidine nitrate, guanidine nitrate, guanidine carbonate, nitroguanidine, dicyandiamide and nitroaminoguanidine nitrate.

Examples of triazine compounds may include melamine, cyanuric acid, ammeline, ammelide, and ammelande. Examples of nitroamine compounds may include cyclo-1,3,5-trimethylene-2,4,6-trinitroamine.

The content of the fuel of component (a) in the molded article of the enhancing agent is preferably 20 to 50 mass %, more preferably 25 to 48 mass %, and even more preferably 28 to 45 mass %.

Component (b)

Examples of the oxidizing agent of component (h) may include perchlorates. The preferred perchlorate is selected from ammonium perchlorate, potassium perchlorate, and sodium perchlorate.

As the oxidizing agent of component (b), a known oxidizing agent other than perchlorates can be used. The content of the perchlorate in the oxidizing agent of component (b) is preferably 50 mass % or more, more preferably 60 mass % or more, and even more preferably 70 mass % of more.

Examples of other oxidizing agents may include copper oxide, basic copper nitrate, sodium nitrate, potassium nitrate, and strontium nitrate.

The content of the oxidizing agent of component (b) in the molded article of the enhancing agent is preferably 40 to 80 mass %, more preferably 45 to 75 mass %, and even more preferably 50 to 70 mass %.

Component (c)

One selected from carboxymethyl cellulose, sodium carboxymethyl cellulose, potassium carboxymethyl cellulose, carboxymethyl cellulose ammonium salt, cellulose acetate, cellulose acetate butyrate, methyl cellulose, ethyl cellulose, hydroxyethyl cellulose, ethylhydroxyethyl cellulose, hydroxypropyl cellulose, carboxymethylethyl cellulose, microcrystalline cellulose, polyacrylamide, polyacrylamide amino compound, polyacryl hydrazide, copolymers of acrylamide and metal salts of acrylic acid, copolymers of polyacrylamide and ester compounds of polyacrylic acid, polyvinyl alcohol, acrylic rubber, guagum, starch, and silicones or a combination of two or more thereof is preferably used as the binder of component (c).

As the binder of component (c), sodium carboxymethyl cellulose, potassium carboxymethyl cellulose, carboxymethyl cellulose ammonium salt are preferred, and particularly sodium carboxymethyl cellulose is more preferred.

The content of the binder of component (c) in the molded article of the enhancing agent is preferably 1 to 20 mass %, more preferably 3 to 15 mass %, and even more preferably 5 to 12 mass %.

Known additives, that are usually compounded for various purposes with gas generating agents, can be compounded, if they meet the invention, with the molded article of the enhancing agent in accordance with the present invention.

Examples of such additives may include metal oxides such as iron oxide, zinc oxide, cobalt oxide, manganese oxide, molybdenum oxide, nickel oxide, bismuth oxide, silica and alumina, metal hydroxides such as cobalt hydroxide and iron hydroxide, metal carbonates or basic metal carbonates such as cobalt carbonate, calcium carbonate, basic zinc carbonate and basic copper carbonate, composite compounds of metal oxides or hydroxides such as Japanese acidic clay, kaolin, talc, bentonite, diatomaceous earth, and hydrotalcite, metal acid salts such as sodium silicate, molybdenic salt of mica, cobalt molybdate, and ammonium molybdate, silicones, molybdenum disulfide, calcium stearate, silicon nitride, and silicon carbide.

The molded article of the enhancing agent in accordance with the present invention can be obtained by a known molding method suitable for the manufacture of a molded article of gas-generating composition.

The molded article of the enhancing agent in accordance with the present invention can be of any desired shape such as a cylindrical shape, cylindrical single-perforated shape, cylindrical perforated (multi-perforated) shape, disk (tablet), or pellet. In the case of cylindrical single-perforated shape, cylindrical perforated (multi-perforated) shape, the hole may be a through hole or a non-through hole (recess). No specific limitation is placed on the cross-sectional shape of the through hole in the width direction thereof. For example, it can be the known cross-sectional shape such as shown in FIGS. 2A-2L of U.S. Pat. No. 5,623,115.

A preferable molded article of the enhancing agent in accordance with the present invention is a single grain or unitary grain type (a molded article of the enhancing agent to be charged and used for a gas generator is preferably composed only by a single molded article), having a cylindrical shape (non-perforated) or a cylindrical multi-perforated shape (having a through hole(s) in the longitudinal direction), for example, being provided with two to ten through holes (most preferably seven through holes).

### EXAMPLES

### Examples and Comparative Examples

Molded bodies of enhancing agents were obtained by the below-described method by using the components shown in Table 1. The combustion temperature, gas output, friction sensitivity, drop hammer sensitivity, burning rate, and heat of combustion were found for the obtained enhancing agent molded bodies.

(Manufacture of Single Grain)

A total of 5000 g of components of the compositions in the examples shown in Table 1 and 1250 g of water were charged into a mixer and mixed. The mixture was extruded with an extruder, cut and dried to obtain a single grain in the form of a cylinder having a diameter of 10 to 13 mm and a height of 9 to 11 mm.

(1) Method for Measuring the Burning Rate

The powder of the compositions in the examples (mixed powder for molding) was charged into a mortar of a predetermined mold, compressed and held for five seconds under a pressure of 14.7 MPa with a hydraulic pump from the end surface of a pestle, then removed, and molded into a cylindrical strand having an outer diameter of 9.6 mm and a length of 12.70 mm. The molded article was dried for 16 hours at 110° C., then an epoxy resin adhesive of a chemical reaction type (“Bond Quick 30”, manufactured by Konishi Co., Ltd.) was applied to the side surface and one end surface of the cylindrical molded article and cured for two hours or more at room temperature. The obtained article was used as a sample.

The cylindrical strand serving as a sample was placed into a SUS hermetic cylinder having an inner capacity of 1 L, pressurized to 6.86 MPa and stabilized, while completely replacing the atmosphere inside the cylinder with nitrogen. A predetermined electric current was then passed through a nichrome wire that was brought into contact with the end surface of the strand and the strand was ignited and burnt by the energy of the current. The behavior of pressure inside the cylinder with time was checked on the chart of a recording device, the time that elapsed from the initiation of combustion to the pressure increase peak was confirmed from the chart scale, and the numerical value obtained by dividing the strand length prior to combustion by the elapsed time was taken as the burning rate.

(2) Combustion Temperature and Gas Output

Combustion temperature and gas output were found by calculations by theoretical formulas.

(3) Friction Sensitivity and Drop Hammer Sensitivity

Friction sensitivity and drop hammer sensitivity were tested by the explosives performance test method of JIS K4810-1979.

(4) Heat of Combustion

Heat of combustion was measured by using a digital calorie measuring unit 1013S-2 of YM Nenken-type, manufactured by Yoshida Seisakusho Co., Ltd. or Yoshida Sakuseisho Co., Ltd.

TABLE 1

| | | Combustion | | Friction | Drop hammer | Heat of | Burning |
|---|---|---|---|---|---|---|---|
| | | temperature | Gas output | sensitivity | Sensitivity | combustion | rate |
| | Composition and composition ratio (mass %) | K | mol/100 g | kgf | cm | cal/g | mml/s |
| Example 1 | BHTN/KClO₄/CMCNa-32.2/62.8/5 | 2816 | 2.85 | 24-36 | >60 | 1149 | 24.23 |
| Example 2 | BHTN/CuO/KClO₄/CMCNa-30.1/10/54.9/5 | 2679 | 2.66 | 24-36 | >60 | 1052 | 28.25 |
| Example 3 | BHTN/CuO/KClO₄/CMCNa-27.9/20/47.1/5 | 2580 | 2.44 | 24-36 | >60 | 909 | 26.17 |
| Comparative | B/KNO₃-25/75 | 3089 | 1.34 | >36.0 | 30-40 | 1646 | — |
| Example 1 | | | | | | | |
| Comparative | B/KNO₃/CMCNa-18.8/76.2/5 | 3090 | 1.7 | >36.0 | >60 | 1546 | 31.98 |
| Example 2 | | | | | | | |
| Comparative | 5AT/B/KNO₃-11/20/69 | 3158 | 1.8 | >36.0 | 40-50 | — | |
| Example 3 | | | | | | | |

BHTN: bitetrazole diammonium salt
KClO₄: potassium perchlorate
CuO: copper oxide
CMCNa: sodium carboxymethyl cellulose
B: boron
KNO₃: potassium nitrate
5AT: 5-aminotetrazole

As is clear from Table 1, the comparison of the single grain enhancing agent (Examples 1 to 3) in accordance with the present invention and known B/KNO₃ (Comparative Example 1) confirms that the ignition effect same as that of expensive B/KNO₃ can be obtained and excellent heat generation per unit and burning rate are attained.

1. A molded article of an enhancing agent comprising:
(a) 20 to 50 mass % of a fuel comprising a bitetrazole salt;
(b) 40 to 80 mass % of an oxidizing agent; and
(c) 1 to 20 mass % of a binder.

2. The molded article of the enhancing agent according to claim 1, wherein the bitetrazole salt of component (a) is monoammonium salt or diammonium salt.

3. The molded article of the enhancing agent according to claim 1, wherein the bitetrazole salt of component (a) is a metal salt.

4. The molded article of the enhancing agent according to claim 1, wherein the bitetrazole salt of component (a) is an alkali metal salt or an alkaline earth metal salt.

5. The molded article of the enhancing agent according to claim 1 or 2, further comprising another nitrogen-containing organic fuel as the fuel of component (a).

6. The molded article of the enhancing agent according to claim 1 or 2, comprising a perchlorate as the oxidizing agent of component (b).

7. The molded article of the enhancing agent according to claim 1 or 2, comprising sodium carboxymethyl cellulose as the binder of component (c).

8. The molded article of the enhancing agent according to claim 1 or 2, of a single grain or unitary grain type being non-perforated or having 1 to 10 through holes.
